(19) United States
(12) Patent Application Publication
(10) Pub. No.: US 2019/0160687 A1
(43) Pub. Date: May 30, 2019

(54) ELECTRONIC DEVICE AND CONTROL DEVICE

(71) Applicant: SHARP KABUSHIKI KAISHA, Sakai City (JP)

(72) Inventor: TOHRU EBISU, Sakai City (JP)

(21) Appl. No.: 16/186,988

(22) Filed: Nov. 12, 2018

(30) Foreign Application Priority Data
Nov. 28, 2017 (JP) 2017-228287

(51) Int. Cl. B25J 13/08; G06N 3/00

(52) U.S. Cl. CPC B25J 13/081; G05B 2219/40202; G06N 3/008

(57) ABSTRACT

The present invention has an object to ensure safety while allowing an electronic device to fulfill its function. At least one contact sensor and at least one driving device are arranged so that an operation of the at least one driving device does not cause a change in positional relationship between the at least one contact sensor and the at least one driving device. A storage device stores therein a correspondence between the at least one contact sensor and the at least one driving device. The control device identifies, from among the at least one contact sensor, a contact sensor which has detected contact of an object; and (i) identify, with reference to the correspondence, a predetermined driving device corresponding to the contact sensor identified and (ii) cause an operation of the predetermined driving device identified to stop.

This Nonprovisional application claims priority under 35 U.S.C. § 119 on Patent Application No. 2017-228287 filed in Japan on Nov. 28, 2017, the entire contents of which are hereby incorporated by reference.

### TECHNICAL FIELD

The present invention relates to an electronic device and a control device.

### BACKGROUND ART

Many human-like robots which have a plurality of movable parts (e.g., a head part, an arm part, and a leg part) have been developed. When a certain movable part of such a robot's is touched by a user while being driven, the user may be harmed by, for example, getting the user's finger nipped. In view of this, various techniques for stopping a movable part of a robot have been proposed.

Patent Literature 1 discloses a robot which allows securing safety of humans and simultaneously achieving an improvement in productivity by preventing a decrease in efficiency of an operation performed by the robot.

### CITATION LIST

### Patent Literature

[Patent Literature 1]

Japanese Patent Application Publication Tokukai No. 2017-61026 (Publication date: Mar. 30, 2017)

### SUMMARY OF INVENTION

### Technical Problem

Conventional techniques for stopping a movable part of a robot involve stopping all of the movements of the entire robot. When such a technique is applied to a robot which exhibits its functions through movements of movable parts, the robot is unable to exhibit its functions at all, since movements of the robot are completely stopped.

One aspect of the present invention is accomplished in view of the above problem. An object of the one aspect of the present invention is to provide an electronic device and the like each of which allows ensuring safety while allowing the electronic device to fulfill its function.

### Solution to Problem

In order to attain the object, an electronic device in accordance with one aspect of the present invention is an electronic device including: at least one detecting device configured to detect contact or approach of an object; at least one driving device; a storage device; and a control device configured to control an operation of the at least one driving device, the at least one detecting device and the at least one driving device being arranged so that the operation of the at least one driving device does not cause a change in positional relationship between the at least one detecting device and the at least one driving device, the storage device storing therein a correspondence between the at least one detecting device and the at least one driving device, the control device being configured to: identify, from among the at least one detecting device, a detecting device which has detected contact of an object; and (i) identify, with reference to the correspondence, a predetermined driving device corresponding to the detecting device identified and (ii) cause an operation of the predetermined driving device identified to stop.

In order to attain the object, a control device in accordance with one aspect of the present invention is a control device for controlling an electronic device, the electronic device including: at least one detecting device configured to detect contact or approach of an object; at least one driving device; and a storage device, the at least one detecting device and the at least one driving device being arranged so that the operation of the at least one driving device does not cause a change in positional relationship between the at least one detecting device and the at least one driving device, the storage device storing therein a correspondence between the at least one detecting device and the at least one driving device, the control device including: a detecting device identification section configured to identify, from among the at least one detecting device, a detecting device which has detected contact of an object; and a driving device control section configured to (i) identify, with reference to the correspondence, a predetermined driving device corresponding to the detecting device identified and (ii) cause an operation of the predetermined driving device identified to stop.

### Advantageous Effects of Invention

According to the one aspects of the present invention, it is possible to ensure safety while allowing an electronic device to fulfill its function.

### BRIEF DESCRIPTION OF DRAWINGS

FIG. 1 is a block diagram illustrating a configuration of a main part of a robot (electronic device) in accordance with one embodiment of the present invention.

FIG. 2 is a flowchart showing a flow of characteristic operations of the robot.

(a) of FIG. 3 is a view illustrating an example of a position on the robot at which position a contact sensor is disposed. (b) of FIG. 3 is a view illustrating an example of a state in which the robot is held by a hand.

(a) of FIG. 4 is a view illustrating another example of a position on the robot at which position a contact sensor is disposed. (b) of FIG. 4 is a view illustrating another example of a state in which the robot is held by a hand.

(a) of FIG. 5 is a view illustrating still another example of a position on the robot at which position a contact sensor is disposed. (b) of FIG. 5 is a view illustrating still another example of a state in which the robot is held by a hand.

### DESCRIPTION OF EMBODIMENTS

[Configuration of Main Parts of Robot]

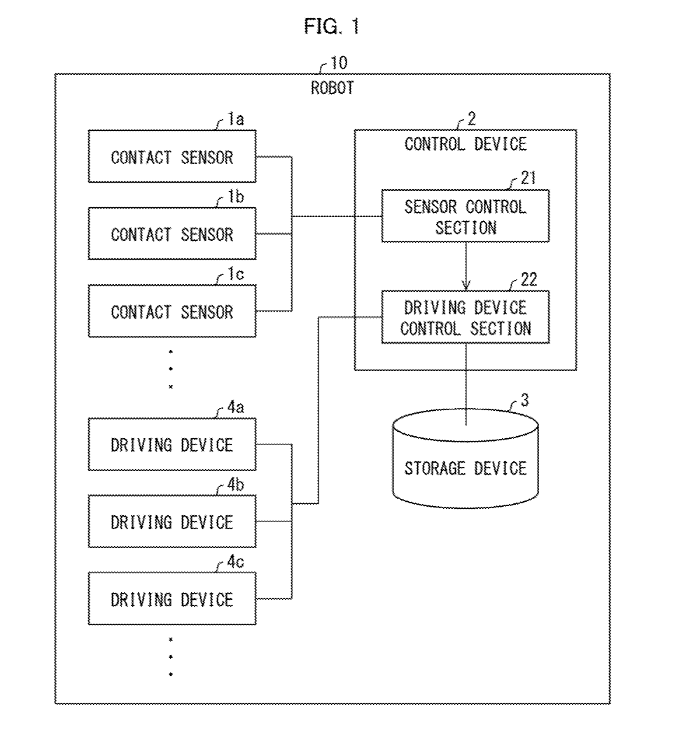

Firstly, a configuration of main parts of a robot (electronic device) 10 in accordance with one embodiment of the present invention will be discussed with reference to FIG. 1. In the following description, a robot is described as an example of the electronic device in accordance with the one embodiment of the present invention. Note, however, that an electronic device to which the present invention is applicable is not limited to robots. The present invention is applicable to any electronic device provided that the electronic device includes (i) a driving device which drives a plurality of movable parts and (ii) a plurality of contact sensors (detecting devices).

Also note that the description herein discusses an example case in which the robot 10 in accordance with the one embodiment of the present invention resembles a human body in appearance (i.e., a humanoid robot). That is, the robot 10 is capable of changing one or more postures (poses), making a gesture (communication motion), etc. for a user by individually moving movable parts such as a head, an arm, a hand, and a leg. Note that the robot 10 is not limited to a human-like shape, and may be in a shape of an animal (a cat, a dog, etc.), an insect, a spider, a centipede, a snake, or the like.

As illustrated in FIG. 1, the robot 10 includes a plurality of contact sensors (detecting devices) 1a through 1c . . . (hereinafter, the contact sensors 1a through 1c are represented by a “contact sensor 1”), a control device 2, a storage device 3, and a plurality of driving devices 4a through 4c . . . (hereinafter, the driving devices 4a through 4c are represented by a “driving device 4”).

The contact sensor 1 is a sensor which detects contact of an object such as a user's hand. In the present Embodiment, the contact sensor 1 is, but not limited to, an electrostatic capacitive sensor. Examples of the contact sensor 1 include a pressure sensor, an optical sensor, and the like. Note that the electrostatic capacitive sensor is capable of detecting a hand of a user even in a case where the electrostatic capacitive sensor and the hand are spaced apart from each other. That is, the contact sensor 1 detects approach of an object such as a user's hand (detects a state in which the user's hand is within a detectable range).

The control device 2 is a device which controls an operation of the contact sensor 1 and controls an operation of the driving device 4. The control device 2 includes a sensor control section (detecting device identification section) 21 and a driving device control section 22.

The sensor control section 21 performs overall control of operations of the respective plurality of contact sensors 1a through 1c . . . . Specifically, the sensor control section 21 has a function of identifying, from among the plurality of contact sensors 1a through 1c . . . , (i) a contact sensor which has detected contact of an object and (ii) a contact sensor which has not detected any contact by an object.

The driving device control section 22 performs overall control of operations of the respective plurality of driving devices 4a through 4c . . . . Specifically, the driving device control section 22 (i) refers to correspondence between the contact sensors 1a through 1c . . . and the driving devices 4a through 4c . . . in table information read out from the storage device 3, so as to identify a driving device corresponding to a contact sensor which has been identified by the sensor control section 21 as having identified contact of an object and (ii) causes an operation of the driving device thus identified to stop. Note that a positional relationship of the identified contact sensor to the corresponding driving device does not change in accordance with an operation of the driving device.

The storage device 3 stores therein table information and the like. The table information indicates, for example, a correspondence between a certain contact sensor and a driving device whose operation is to be stopped in a case where the certain contact sensor has detected contact of an object. The driving device control section 22 refers to the table information so as to determine a driving device whose operation is to be stopped. The driving device control section 22 is configured to let continue, instead of causing to stop, operations of the other driving devices than the driving device whose operation is to be stopped. This, in contrast to an arrangement in which motions of all driving devices are caused to stop, allows the robot 10 to fulfill its function.

The driving device control section 22 may be configured such that, in a case where a plurality of driving devices are present, the driving device control section 22 causes an operation of a driving device, which is located the closest to a specified contact sensor, to stop. An operation of a driving device which is located the closest to a certain contact sensor may harm a user, for example, by nipping a user's finger that comes in contact with the contact sensor. The above-described configuration thus allows securing safety of the robot 10. Each of the driving devices 4a through 4c . . . is a device which causes a movable part (e.g., a head, an arm, or a leg) of the robot 10 to move or causes a motion of the movable part to stop.

According to the above-described configuration, during an operation of a predetermined driving device of the robot 10, a positional relationship between a contact sensor and the predetermined driving device does not change. Then, when an object makes contact or approach to the contact sensor corresponding to the predetermined driving device, the operation of the driving device is caused to stop.

Accordingly, in a case where (i) an object has made contact or approach to a position and (ii) it is undesirable to drive a driving device in a state where an object has made contact or approach to the position, it is possible to cause an operation of the driving device to stop. For example, in a case where a finger of a user has come into contact with a position at which the finger will be nipped if the driving device is driven, an operation of the driving device can be stopped so as to prevent nipping of the finger from occurring.

Meanwhile, in a case where a contact sensor is provided at a portion (e.g., a tip of an arm of the robot 10) whose positional relationship to a driving device (a driving device such as a shoulder joint of the robot) changes during driving of the driving device, timing at which the driving of the driving device is stopped varies undesirably, depending on a position to which the arm has moved. For example, even in a case where the arm of the robot 10 has been raised and thus the user is not in danger of having the user's finger nipped between the arm and the trunk of the robot 10, driving of the driving device is stopped when the user comes in contact with the tip of the arm. Stopping the driving of the driving device despite in a safe situation prevents the robot from making natural motions, and also creates a risk of lowering the satisfaction level of the user who has to experience a stop of driving of the robot at unnecessary timing.

Further, the robot 10 having the above-described configuration involves stopping only driving of a certain driving device corresponding to a specified contact sensor, instead of stopping driving of all of the driving devices uniformly. This allows ensuring safety while allowing the robot 10 to fulfill its function.

[Characteristic Operations of Robot]

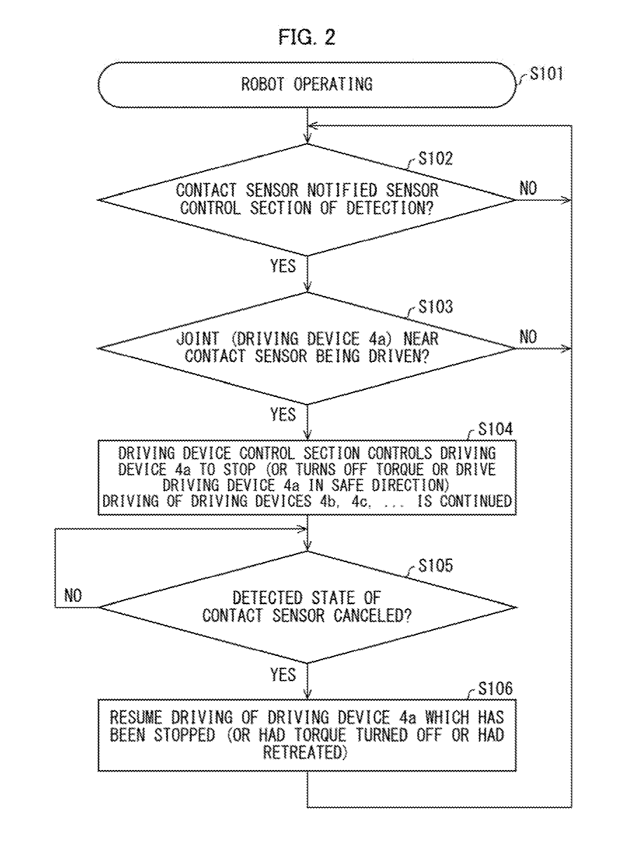

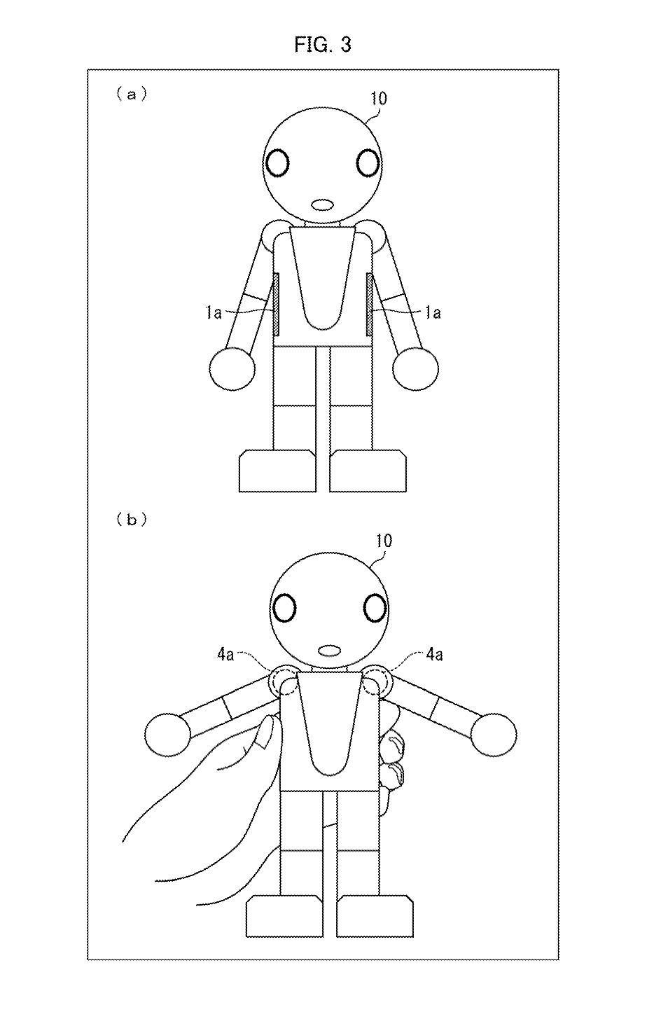

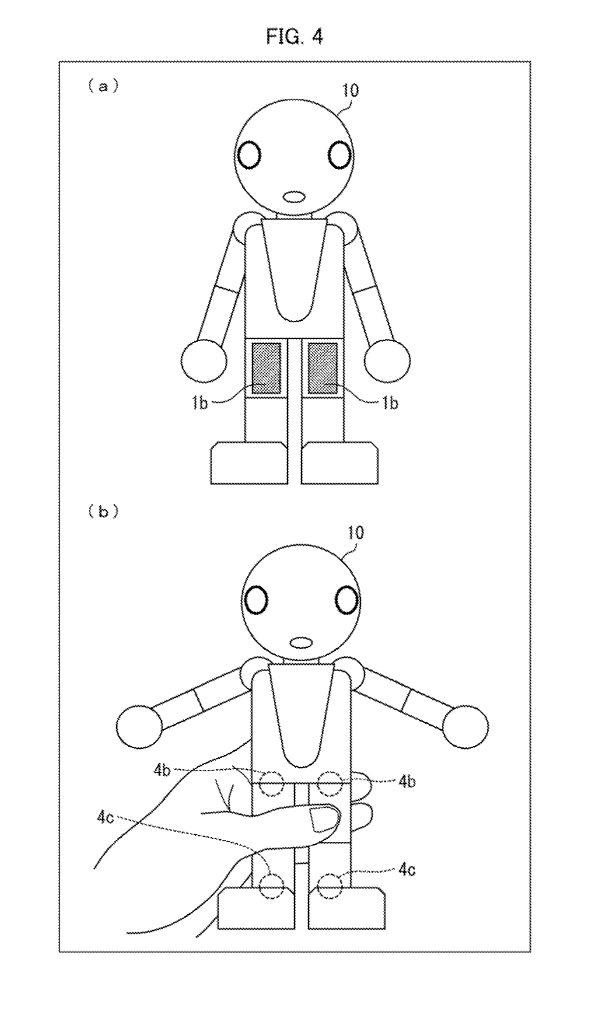

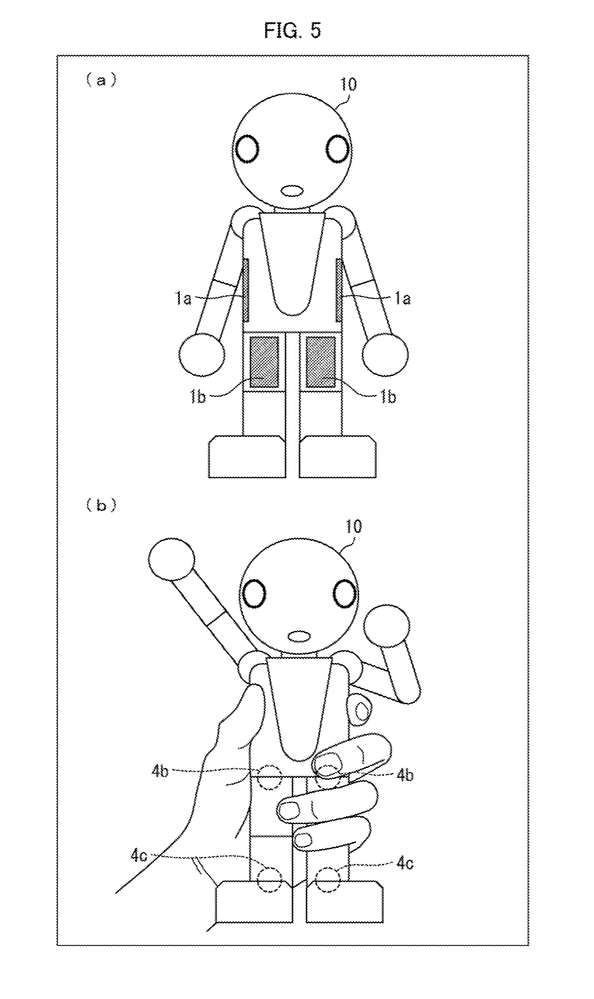

With reference to FIG. 2, the following description will discuss a flow of characteristic operations of the robot 10. At step S101 (hereinafter, the term “step” will be omitted), the robot 10 is operating. Then, the flow proceeds to S102.

At S102, the sensor control section 21 confirms whether or not a certain contact sensor has given the sensor control section 21 a notification that an object has been detected. In a case where it is confirmed that the notification has been given, the flow proceeds to S103, whereas in a case where the notification has not been made, the flow returns to S102.

At S103, the driving device control section 22 confirms whether or not a joint (e.g., the driving device 4a) near the contact sensor is being driven. In a case where it is confirmed that the driving device 4a is being driven, the flow proceeds to S104, whereas in a case where it is confirmed that the driving device 4a has stopped operating, the flow proceeds to S102.

At S104, the driving device control section 22 causes the driving device 4a to stop making motions, and the process proceeds to S105. Alternatively, in a case where the driving device 4a is a motor, a torque of the motor is turned off or a movable part is caused to make a motion in a safe direction. At this time, the driving devices 4b, 4c, . . . other than the driving device 4a continue to be driven.

At S105, the sensor control section 21 confirms whether or not a detected state of the contact sensor has been canceled. In a case where it is confirmed that a detected state of the contact sensor has been canceled, the flow proceeds to S106, whereas in a case where it is confirmed that a detected state of the contact sensor has not been canceled, the flow returns to S105. At S106, the driving device 4a whose operation has been stopped (the motor whose torque has been turned off or the driving device 4a which has retreated) starts to be driven again, and the flow returns to S102.

[Specific Example of Operation of Robot]

(a) of FIG. 3 illustrates an example in which the contact sensor 1a is disposed on both side portions of the trunk of the robot 10. In this example, in a case where a hand of a user holds the robot 10 so as to sandwich the both side portions of the trunk as illustrated in (b) of FIG. 3, the user's finger may be caught between the trunk and a base of an arm when a shoulder joint (driving device 4a) is driven. As such, in this case, driving of the driving device 4a is stopped so as to prevent the user's finger from being caught between the trunk and the base of the arm.

(a) of FIG. 4 illustrates an example in which the contact sensor 1b is disposed on side surfaces of upper leg parts of the robot 10 at joints between the upper leg parts and the trunk. In this example, in a case where a hand of a user holds the robot 10 so as to sandwich the upper leg parts as illustrated in (b) of FIG. 4, the user's finger may be caught in a joint portion between an upper leg part and a lower leg part when a leg joint (driving device 4b or 4c) is driven. As such, in this case, driving of the driving devices 4b and 4c is stopped so as to prevent the user's finger from being caught in a joint portion between an upper leg part and a lower leg part.

(a) of FIG. 5 illustrates an example in which (i) the contact sensor 1a is disposed on both side sections of the trunk of the robot 10 and (ii) the contact sensor 1b is disposed on side surfaces of upper leg parts of the robot 10 at joints between the upper leg parts and the trunk. In this example, in a case where a hand of a user holds the robot 10 so as to sandwich the both side portions of the trunk and sandwich the upper leg parts as illustrated in (b) of FIG. 5, the user's finger may be caught between the trunk and a base of an arm and/or the user's finger may be caught in a joint portion between an upper leg part and a lower leg part when a shoulder joint (driving device 4a) is driven and/or when a leg joint (driving device 4b or 4c) is driven. As such, in this case, driving of the driving devices 4a through 4c is stopped so as to prevent the user's finger from being caught between the trunk and a base of an arm and from being caught in a joint portion between an upper leg part and a lower leg part.

In the above-described example cases, the contact sensors 1a through 1c are disposed on both side sections of the trunk of the robot 10 or on side surfaces of upper leg parts at joints between the upper leg parts and the trunk. Note, however, that positions at which the contact sensors are disposed are not limited to these examples. Further, although the above-described example cases involved stopping driving of shoulder joints and/or leg joints, a joint whose motion is to be stopped in a case where contact has been detected by a certain contact sensor is not limited to a shoulder joint and a leg joint, and may be any joint.

[Software Implementation Example]

Control blocks of the control device 2 (particularly, the sensor control section 21 and the driving device control section 22) of the robot 10 may be realized by a logic circuit (hardware) provided in an integrated circuit (IC chip) or the like or may be realized by software.

In the latter case, the control device 2 includes a computer that executes instructions of a program that is software realizing the foregoing functions. The computer, for example, includes at least one processer (control device) and at least one computer-readable storage medium storing the program. The object of the present invention can be achieved by the processer of the computer reading and executing the program stored in the storage medium. The processor may be, for example, a CPU (Central Processing Unit). The storage medium may be “a non-transitory tangible medium” such as a ROM (Read Only Memory), a tape, a disk, a card, a semiconductor memory, and a programmable logic circuit. The computer may further include a RAM (Random Access Memory) or the like that develops the program in executable form. Further, the program may be supplied to or made available to the computer via any transmission medium (such as a communication network and a broadcast wave) which enables transmission of the program. Note that one aspect of the present invention can also be implemented by the program in the form of a computer data signal embedded in a carrier wave which is embodied by electronic transmission.

[Recap]

An electronic device (robot 10) in accordance with Aspect 1 of the present invention is an electronic device including: at least one detecting device (contact sensors 1a, 1b, 1c, . . . ) configured to detect contact or approach of an object; at least one driving device (4a, 4b, 4c, . . . ); a storage device (3); and a control device (2) configured to control an operation of the at least one driving device, the at least one detecting device and the at least one driving device being arranged so that the operation of the at least one driving device does not cause a change in positional relationship between the at least one detecting device and the at least one driving device, the storage device storing therein a correspondence between the at least one detecting device and the at least one driving device, the control device being configured to: identify, from among the at least one detecting device, a detecting device which has detected contact of an object; and (i) identify, with reference to the correspondence, a predetermined driving device corresponding to the detecting device identified and (ii) cause an operation of the predetermined driving device identified to stop.

According to the above-described configuration, during an operation of a predetermined driving device of the electronic device, a positional relationship between a detecting device and the predetermined driving device does not change. Then, when an object makes contact or approach to the detecting device corresponding to the predetermined driving device, the operation of the driving device is caused to stop. Accordingly, in a case where (i) an object has made contact or approach to a position and (ii) it is undesirable to drive a driving device in a state where an object has made contact or approach to the position, it is possible to cause an operation of the driving device to stop. For example, in a case where a finger of a user has come into contact with a position at which the finger will be nipped if the driving device is driven, an operation of the driving device can be stopped so as to prevent nipping of the finger from occurring.

Meanwhile, in a case where a detecting device is provided at a portion (e.g., a tip of an arm of a robot) whose positional relationship to a driving device (a driving device such as a shoulder joint of the robot) changes during driving of the driving device, timing at which the driving of the driving device is stopped varies undesirably, depending on a position to which the arm has moved. For example, even in a case where the arm of the robot has been raised and thus the user is not in danger of having the user's finger nipped between the arm and the trunk of the robot, driving of the driving device is stopped when the user comes in contact with the tip of the arm. Stopping the driving of the driving device despite in a safe situation prevents the robot from making natural motions, and also creates a risk of lowering the satisfaction level of the user who has to experience a stop of driving of the robot at unnecessary timing.

Further, the above-described configuration involves stopping only driving of a certain driving device corresponding to a specified detecting device, instead of stopping driving of all of the driving devices uniformly. This allows ensuring safety while allowing the electronic device to fulfill its function.

In Aspect 2 of the present invention, the electronic device in accordance with above Aspect 1 is preferably configured such that the control device lets continue, instead of causing to stop, an operation of the other driving device(s) than the driving device whose operation is to be stopped. This configuration, in contrast to an arrangement in which motions of all driving devices are caused to stop, allows the electronic device to fulfill its function.

In Aspect 3 of the present invention, the electronic device in accordance with above Aspect 1 or 2 may be configured such that in a case where the at least one driving device is a plurality of driving devices, the control device causes an operation of a driving device, which is located the closest to the detecting device identified among the plurality of driving devices, to stop. An operation of a driving device which is located the closest to a certain detecting device may harm a user, for example, by nipping a user's finger that comes in contact with the detecting device. The above-described configuration thus allows securing safety of the electronic device.

A control device in accordance with Aspect 4 of the present invention is a control device for controlling an electronic device, the electronic device including: at least one detecting device configured to detect contact or approach of an object; at least one driving device; and a storage device, the at least one detecting device and the at least one driving device being arranged so that the operation of the at least one driving device does not cause a change in positional relationship between the at least one detecting device and the at least one driving device, the storage device storing therein a correspondence between the at least one detecting device and the at least one driving device, the control device comprising: a detecting device identification section (sensor control section 21) configured to identify, from among the at least one detecting device, a detecting device which has detected contact of an object; and a driving device control section (22) configured to (i) identify, with reference to the correspondence, a predetermined driving device corresponding to the detecting device identified and (ii) cause an operation of the predetermined driving device identified to stop.

The control device in accordance with the foregoing aspects of the present invention may be realized by a computer. In this case, the present invention encompasses: a control program for the control device which program causes a computer to operate as the foregoing sections (software sections) of the control device so that the control device can be realized by the computer; and a computer-readable storage medium storing the control program therein.

[Additional Matter]

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1a through 1c: contact sensor (detecting device)
2: control device
3: storage device
4a through 4c: driving device
10: robot (electronic device)
21: sensor control section (detecting device identification section)
22: driving device control section

1. An electronic device comprising:
at least one detecting device configured to detect contact or approach of an object;
at least one driving device;
a storage device; and
a control device configured to control an operation of the at least one driving device,
the at least one detecting device and the at least one driving device being arranged so that the operation of the at least one driving device does not cause a change in positional relationship between the at least one detecting device and the at least one driving device,
the storage device storing therein a correspondence between the at least one detecting device and the at least one driving device,
the control device being configured to:
identify, from among the at least one detecting device, a detecting device which has detected contact of an object; and
(i) identify, with reference to the correspondence, a predetermined driving device corresponding to the detecting device identified and (ii) cause an operation of the predetermined driving device identified to stop.

2. The electronic device as set forth in claim 1, wherein
the control device lets continue, instead of causing to stop, an operation of the other driving device(s) than the driving device whose operation is to be stopped.

3. The electronic device as set forth in claim 1, wherein
in a case where the at least one driving device is a plurality of driving devices, the control device causes an operation of a driving device, which is located the closest to the detecting device identified among the plurality of driving devices, to stop.

4. A control device for controlling an electronic device,
the electronic device including:
at least one detecting device configured to detect contact or approach of an object;
at least one driving device; and
a storage device,
the at least one detecting device and the at least one driving device being arranged so that the operation of the at least one driving device does not cause a change in positional relationship between the at least one detecting device and the at least one driving device,
the storage device storing therein a correspondence between the at least one detecting device and the at least one driving device,
the control device comprising:
a detecting device identification section configured to identify, from among the at least one detecting device, a detecting device which has detected contact of an object; and
a driving device control section configured to (i) identify, with reference to the correspondence, a predetermined driving device corresponding to the detecting device identified and (ii) cause an operation of the predetermined driving device identified to stop.
